(19) United States
(12) Patent Application Publication
(10) Pub. No.: US 2010/0217590 A1
(43) Pub. Date: Aug. 26, 2010

(54) SPEAKER LOCALIZATION SYSTEM AND METHOD

(75) Inventors: Elias Nemer, Irvine, CA (US); Jes Thyssen, Laguna Niguel, CA (US)

Correspondence Address: FIALA & WEAVER, P.L.L.C.;C/O CPA GLOBAL, P.O. BOX 52050, MINNEAPOLIS, MN, 55402, US

(73) Assignee: BROADCOM CORPORATION, Irvine, CA (US)

(21) Appl. No.: 12/391,879

(22) Filed: Feb. 24, 2009

(51) Int. Cl. G10L 15/20

(52) U.S. Cl. 704/233; 704/E15.039

(57) ABSTRACT

A system and method for performing speaker localization is described. The system and method utilizes speaker recognition to provide an estimate of the direction of arrival (DOA) of speech sound waves emanating from a desired speaker with respect to a microphone array included in the system. Candidate DOA estimates may be preselected or generated by one or more other DOA estimation techniques. The system and method is suited to support steerable beamforming as well as other applications that utilize or benefit from DOA estimation. The system and method provides robust performance even in systems and devices having small microphone arrays and thus may advantageously be implemented to steer a beamformer in a cellular telephone or other mobile telephony terminal featuring a speakerphone mode.

### BACKGROUND OF THE INVENTION

1. Field of the Invention

The present invention relates to systems that automatically estimate the direction of arrival of sound waves emanating from a speaker or other audio source using a microphone array.

2. Background

Systems exist that estimate the direction of arrival (DOA) of sound waves emanating from an audio source using an array of microphones. This estimation process may be referred to as audio source localization or speaker localization in the specific case where the audio source of interest is a speaker. The principle of audio source localization is generally based on the Time Difference of Arrival (TDOA) of the sound waves emanating from the audio source to the various microphones in the array and the geometric inference of the source location therefrom.

There are many applications of audio source localization. For example, in certain audio teleconferencing systems, audio source localization is used to steer a beamformer implemented using a microphone array towards a speaker, thereby enabling a speech signal associated with the speaker to be passed or even enhanced while enabling audio signals associated with unwanted audio sources to be attenuated. Such conventional audio teleconferencing systems typically rely on relatively large microphone arrays and complex digital signal processing algorithms to perform the localization function.

Many conventional cellular telephones feature a speakerphone mode that allows a person using the telephone to engage in a conversation even when the telephone is distanced from the person's face. However, when the speakerphone feature of the cellular telephone is used in a noisy environment such as a car or a crowded public space, noise from unwanted audio sources will often be picked up by the speakerphone, thereby impairing the quality and intelligibility of the person's speech as perceived by a far-end listener.

Thus, a cellular telephone operating in a speakerphone mode could benefit from the use of a steerable beamformer to pass or even enhance speech signals associated with a near-end talker while attenuating audio signals associated with unwanted audio sources. However, because cellular telephones are often used in high noise environments, any audio source localization technique used to steer such a beamformer would need to be extremely robust. Achieving such robust performance in a cellular telephone using conventional techniques will be difficult for a number of reasons. For example, the compact design of most cellular telephones inherently limits the number of microphones that can be used to perform localization and also the spacing between them.

What is needed then is an improved system and method for performing audio source localization, such as speaker localization. The improved system and method should preferably be suited to support certain applications, such as steerable beamforming. In particular, the improved system and method should robustly perform audio source localization in a manner that does not rely on a large array of microphones so that it may be used to steer a beamformer in a cellular telephone or other mobile telephony terminal featuring a speakerphone mode.

### BRIEF SUMMARY OF THE INVENTION

A system and method for performing speaker localization is described herein. The system and method utilizes speaker-recognition to provide an estimate of the direction of arrival (DOA) of speech sound waves emanating from a desired speaker with respect to a microphone array. Candidate DOAs may be preselected or generated by one or more other DOA estimation techniques. The system and method is suited to support steerable beamforming as well as other applications that utilize or benefit from DOA estimation. The system and method provides robust performance even in systems and devices having small microphone arrays and thus may advantageously be implemented to steer a beamformer in a cellular telephone or other mobile telephony terminal featuring a speakerphone mode.

In particular, a method for determining an estimated DOA of speech sound waves emanating from a desired speaker with respect to a microphone array is described herein. In accordance with the method, a plurality of audio signals corresponding to a plurality of DOAs is acquired from a steerable beamformer. Each of the plurality of audio signals is processed to generate a plurality of processed feature sets, wherein each processed feature set in the plurality of processed feature sets is associated with a corresponding DOA in the plurality of DOAs. A recognition score is generated for each of the processed features sets, wherein generating a recognition score for a processed feature set comprises comparing the processed feature set to a speaker recognition reference model associated with the desired speaker. The estimated DOA is then selected from among the plurality of DOAs based on the recognition scores.

The foregoing method may be implemented, for example, in a mobile telephony terminal and the foregoing steps may be performed responsive to determining that the mobile telephony terminal is being operated in a speakerphone mode.

The foregoing method may further include providing the estimated DOA to the steerable beamformer for use in steering a directional response pattern of the microphone array toward the desired speaker.

The foregoing method may also include generating the speaker recognition reference model associated with the desired speaker. Generating the speaker recognition reference model associated with the desired speaker may include acquiring speech data from the steerable beamformer based on a fixed DOA, extracting features from the acquired speech data, and processing the features extracted from the acquired speech data to generate the speaker recognition reference model. In an embodiment in which the method is implemented in a mobile telephony terminal, the speaker recognition reference model may be generated responsive to determining that a user has placed, is placing, or has received a telephone call using the mobile telephony terminal. In further accordance with such an embodiment, the generation of the speaker recognition reference model may include selecting the fixed DOA based on whether the user has placed, is placing, or has received the telephony call using the mobile telephony terminal in a handset mode or a speakerphone mode.

The foregoing method may further include obtaining the plurality of DOAs from a database of possible DOAs. Alternatively, the plurality of DOAs may be obtained from a non-speaker-recognition based DOA estimator, such as a correlation-based DOA estimator.

An alternative method for determining an estimated DOA of speech sound waves emanating from a desired speaker with respect to a microphone array is also described herein. In accordance with the method, a plurality of non-speaker-recognition based DOA estimation techniques are applied to audio signals received from the microphone array to generate a corresponding plurality of candidate DOAs. A speaker recognition based DOA estimation technique is then applied to audio signals received from a steerable beamformer implemented using the microphone array at each of the candidate DOAs to select the estimated DOA from among the plurality of candidate DOAs. In accordance with this method, applying the plurality of non-speaker-recognition based DOA estimation techniques may include applying at least one of a correlation-based DOA estimation technique or an adaptive eigenvalue based DOA estimation technique.

A further alternative method for determining an estimated DOA of speech sound waves emanating from a desired speaker with respect to a microphone array is described herein. In accordance with the method, a non-speaker-recognition based DOA estimation technique is applied to audio signals received from the microphone array to generate a corresponding plurality of candidate DOAs. A speaker recognition based DOA estimation technique is then applied to audio signals received from a steerable beamformer implemented using the microphone array at each of the candidate DOAs to select the estimated DOA from among the plurality of candidate DOAs.

In accordance with the foregoing method, applying the non-speaker-recognition based DOA estimation technique to audio signals received from the microphone array to generate a corresponding plurality of candidate DOAs may include applying a correlation-based DOA estimation technique to identify a plurality of DOAs corresponding to a plurality of maxima of an autocorrelation function and identifying each of the plurality of DOAs as a candidate DOA. Applying the correlation-based DOA estimation technique may include performing a cross-correlation for each of a plurality of lags across each of a plurality of frequency sub-bands to identify a lag for each frequency sub-band at which an autocorrelation function is at a maximum, performing histogramming to identify a subset of lags from among the lags identified for the frequency sub-bands corresponding to a plurality of dominant audio sources, and using each lag in the subset of lags as a candidate to determine or represent a candidate DOA.

A method for estimating a DOA of speech sound waves emanating from a desired speaker with respect to a microphone array is also described herein. In accordance with the method, an audio signal is acquired from a steerable beamformer corresponding to a current DOA. The audio signal is processed to generate a processed feature set. The processed feature set is compared with a speaker recognition reference model associated with the desired speaker to generate a recognition score. The current DOA is then updated based on at least the recognition score to generate an updated DOA.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a front perspective view of an example mobile telephony terminal in which an embodiment of the present invention may be implemented.

FIG. 2 is a block diagram of an example transmit processing path of a mobile telephony terminal in which an embodiment of the present invention may be implemented.

FIG. 3 is a block diagram that illustrates an example implementation of a speech direction of arrival (DOA) estimator in accordance with the present invention.

FIG. 4 depicts a flowchart of a method for estimating a DOA of speech sound waves emanating from a desired speaker in accordance with an embodiment of the present invention.

FIG. 5 depicts a flowchart of a method for generating a speaker recognition reference model for a user when the user has placed a telephone call in a handset mode of a mobile telephony terminal in accordance with an embodiment of the present invention.

FIG. 6 illustrates one example of how a user might be expected to hold a mobile telephony terminal to his/her face while operating the mobile telephony terminal in a handset mode.

FIG. 7 depicts a flowchart of a method for generating a speaker recognition reference model for a user when the user is placing a telephone call in a speakerphone mode of a mobile telephony terminal in accordance with an embodiment of the present invention.

FIG. 8 illustrates one example of how a user might be expected to hold a mobile telephony terminal while operating the mobile telephony terminal in a speakerphone mode.

FIG. 9 depicts a flowchart of a method for generating a speaker recognition reference model for a user when the user has received a telephone call in a handset mode of a mobile telephony terminal in accordance with an embodiment of the present invention.

FIG. 10 depicts a flowchart of a method for generating a speaker recognition reference model for a user when the user has received a telephone call in a speakerphone mode of a mobile telephony terminal in accordance with an embodiment of the present invention.

FIG. 11 is a block diagram that illustrates an alternative example implementation of a speech DOA estimator in accordance with the present invention.

FIG. 12 depicts a flowchart of a method for estimating a DOA of speech sound waves emanating from a desired speaker that combines multiple non-speaker-recognition based DOA estimation techniques and a speaker recognition based DOA estimation technique in accordance with an embodiment of the present invention.

FIG. 13 depicts a flowchart of a method for estimating a DOA of speech sound waves emanating from a desired speaker that combines a non-speaker-recognition based DOA estimation technique and a speaker recognition based DOA estimation technique in accordance with an embodiment of the present invention.

FIG. 14 is a block diagram that illustrates a further alternative example implementation of a speech DOA estimator in accordance with the present invention.

FIG. 15 is a block diagram of an example computer system that may be used to implement aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

An embodiment of the present invention will be described herein with reference to an example mobile telephony terminal suitable for use in a cellular telephony system. However, the present invention is not limited to this implementation. Based on the teachings provided herein, persons skilled in the relevant art(s) will appreciate that the present invention may be implemented in any stationary or mobile system or device in which speech or audio signals are received via an array of microphones and subsequently stored, transmitted to another system/device, or used for performing a particular function.

Furthermore, although the speaker localization techniques that are described herein are used to provide input for controlling a steerable beamformer, persons skilled in the relevant art(s) will appreciate that the speaker localization techniques may be used in many other applications, such as for example applications involving blind source separation and independent component analysis. Thus, the present invention is not limited to beamforming applications only.

### B. Example Mobile Telephony Terminal in which an Embodiment of the Present Invention May be Implemented

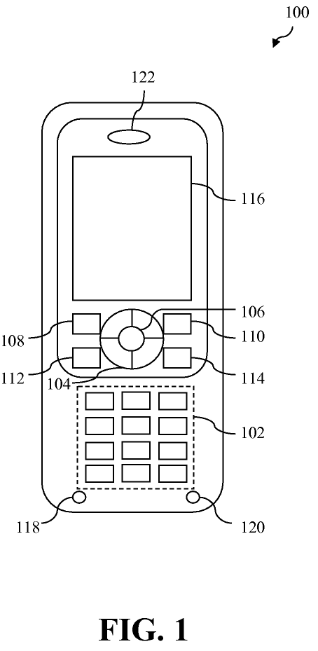

FIG. 1 is a front perspective view of an example mobile telephony terminal 100 in which an embodiment of the present invention may be implemented. Mobile telephony terminal 100 is intended to represent a mobile handset suitable for use in a cellular telephony system. Among other features, mobile telephony terminal 100 includes such conventional components as a keypad 102, a four-way scroll pad 104 and associated selection/activation button 106 (sometimes informally referred to as an “OK” button), and four control buttons 108, 110, 112 and 114, each of which may be used to receive user input. Mobile telephony terminal 100 further includes a display 116 that is used to present images to a user that may comprise, for example, textual, graphic and/or video content. In certain implementations, a user may input a telephone number via keypad 102 or select a telephone number from a contact list presented via display 116 and then activate one of control buttons 108, 110, 112 or 114 to place a telephone call using mobile telephony terminal 100. In certain implementations, a user may also view information about an incoming telephone call via display 116 and accept the call by activating one of control buttons 108, 110, 112 or 114.

As further shown in FIG. 1, mobile telephony terminal 100 includes two microphones 118 and 120 for receiving audio input from a user. Each of these microphones comprises an acoustic-to-electric transducer that operates in a well-known manner to convert sound waves into an analog electrical signal. Taken together, microphones 118 and 120 comprise a microphone array that may be used by mobile telephony terminal 100 to perform speaker localization and beamforming functions that will be described in more detail herein. Such functions advantageously allow mobile telephony terminal 100 to improve the perceptual quality and intelligibility of speech signals received by microphones 118 and 120 from a near-end speaker while mobile telephony terminal 100 is operating in a speakerphone mode. Such functions also enable mobile telephony terminal 100 to attenuate noise or other audio input emanating from undesired audio sources while operating in the speakerphone mode. In an embodiment, the speakerphone mode may be activated by pressing one of control buttons 108, 110, 112 or 114 and/or by interacting with a graphical user interface (GUI) presented via display 116 using 4-way scroll pad 104 and associated selection/activation button 106, although these are only examples.

Although mobile telephony terminal 100 is shown as including a microphone array that consists of two microphones 118 and 120, the microphone array may also include more than two microphones depending upon the implementation.

Mobile telephony terminal 100 also includes an audio speaker 122 by which a near-end listener can hear the voice of a far-end speaker during a telephone conversation. Audio speaker 122 comprises an electro-mechanical transducer that operates in a well-known manner to convert analog electrical signals into sound waves for perception by a user. Depending upon the implementation, mobile telephony terminal 100 may include one or more audio speakers in addition to audio speaker 122.

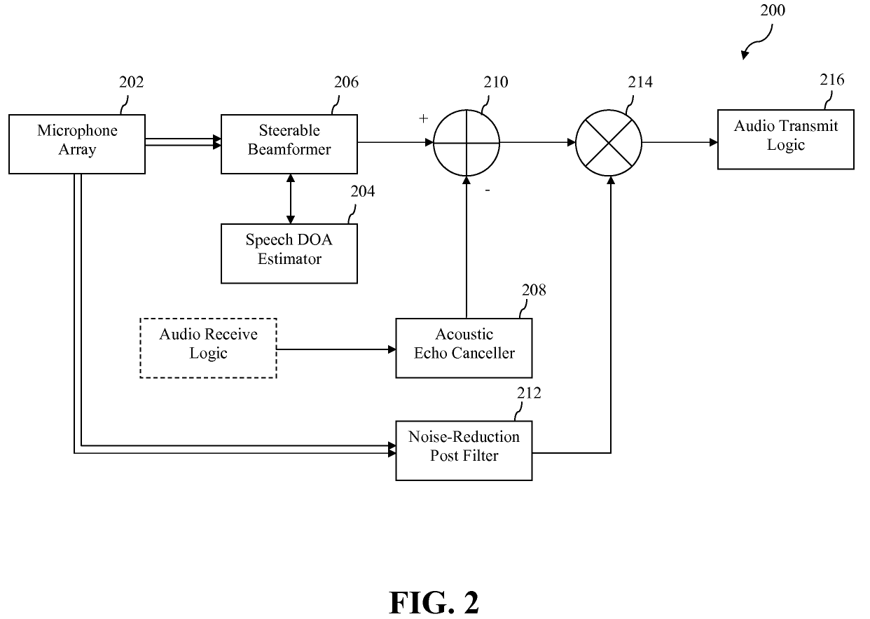

FIG. 2 is a block diagram 200 of an example transmit processing path 200 of mobile telephony terminal 100 in accordance with one embodiment of the invention. As shown in FIG. 2, example transmit processing path 200 includes a microphone array 202, a speech direction of arrival (DOA) estimator 204, a steerable beamformer 206, an acoustic echo canceller 208, a combiner 210, a noise-reduction post-filter 212, a mixer 214 and audio transmit logic 216. It is to be understood that each of elements 204, 206, 208, 210, 212, 214 and 216 may be implemented in hardware using analog and/or digital circuits, in software, through the execution of instructions by one or more general purpose or special-purpose processors, or as a combination of hardware and software.

Microphone array 202 comprises two or more microphones. In the embodiment shown in FIG. 1, microphone array 202 comprises two microphones 118 and 120 although more may be used depending upon the implementation. Each microphone in microphone array 202 operates to convert sound waves into a corresponding analog audio signal. As shown in FIG. 2, the analog audio signals produced by microphone array 202 are provided to steerable beamformer 206 and noise-reduction post-filter 212. In an embodiment, microphone array 202 further comprises an analog-to-digital (A/D) converter corresponding to each microphone so that the analog audio signals may be converted to digital audio signals prior to transmission to these other elements.

Speech DOA estimator 204 is configured to determine an estimated DOA of speech sound waves emanating from a desired speaker with respect to microphone array 202 and to provide the estimated DOA to steerable beamformer 206. In one implementation, the estimated DOA is specified as an angle formed between a direction of propagation of the speech sound waves and an axis along which the microphones in microphone array 202 lie, which may be denoted θ. This angle is sometimes referred to as the angle of arrival. In another implementation, the estimated DOA is specified as a time difference between the times at which the speech sound waves arrive at each microphone in microphone array 202 due to the angle of arrival. This time difference or lag may be denoted τ.

When mobile telephony terminal 100 is operating in a handset (i.e., non-speakerphone) mode, the estimated DOA provided by speech DOA estimator 204 comprises a fixed DOA. Such a fixed DOA may be selected during manufacturing based on a variety of factors or assumptions, such as the design of mobile telephony terminal 100 and the manner in which a user is expected to hold mobile telephony terminal 100 to his/her face. When mobile telephony terminal 100 is operating in a speakerphone mode, the estimated DOA provided by speech DOA estimator 204 comprises a dynamically-changing value that is determined in accordance with an adaptive speaker localization technique that will be described in more detail herein.

Steerable beamformer 206 is configured to combine each of the audio signals received from microphone array 202 to produce a single output audio signal. Steerable beamformer is configured to combine the audio signals in a manner that effectively steers a directional response of microphone array 202 towards a desired speaker, thereby enhancing the quality of the audio signal received from the desired speaker and reducing noise from undesired audio sources. Such steering is performed based on the estimated DOA provided by speech DOA estimator 204 as noted above.

Various techniques for implementing a steerable beamformer are known in the art. In one implementation, steerable beamformer 206 multiplies each of the audio signals received from microphone array 202 by a corresponding weighting factor, wherein each weighting factor has a magnitude and phase, and then sums the resulting products to produce the output audio signal. In further accordance with this implementation, steerable beamformer 206 may modify the weighting factors before summing the products to alter the directional response of microphone array 202 in response to a change in the estimated DOA provided by speech DOA estimator 204. For example, by modifying the amplitude of the weighting factors before summing, steerable beamformer 206 can modify the shape of a directional response pattern of microphone array 202 and by modifying the phase of the weighting factors before summing, steerable beamformer 206 can control an angular location of a main lobe of a directional response pattern of microphone array 202. However, this is only an example and other methods for performing steerable beamforming may be used.

Acoustic echo canceller 208 is configured to receive information from audio receive logic of mobile telephony terminal 100 that is representative of an audio signal to be played back via one or more audio speakers of mobile telephony terminal 100. Acoustic echo canceller 208 is further configured to process this information to generate an estimate of an acoustic echo within the audio signal output by steerable beamformer 206. The estimate of the acoustic echo is then provided to combiner 210 which operates to remove the estimated acoustic echo from the audio signal output from steerable beamformer 206. Various techniques for performing acoustic echo cancellation are known in the art and may be used to implement acoustic echo canceller 208.

Noise-reduction post-filter 212 comprises a filter that is applied via mixer 214 to the audio signal output from combiner 210 in order to reduce noise or other impairments present in that signal. One or more filter parameters of noise-reduction post-filter 212 are modified adaptively over time in response to the audio signals received from microphone array 202. Various techniques for performing noise-reduction post-filtering are known in the art and may be used to implement noise-reduction post-filter 212.

As shown in FIG. 2, the filtered audio signal output by mixer 214 is received for subsequent processing by audio transmit logic 216. Audio transmit logic 216 represents various components of mobile telephony terminal 100 that operate to convert the filtered audio signal output by mixer 214 into a form that is suitable for wireless transmission and that wirelessly transmit the converted signal to one or more other systems or devices within a cellular telephony system.

### C. Example Speech DOA Estimator in Accordance with an Embodiment of the Present Invention

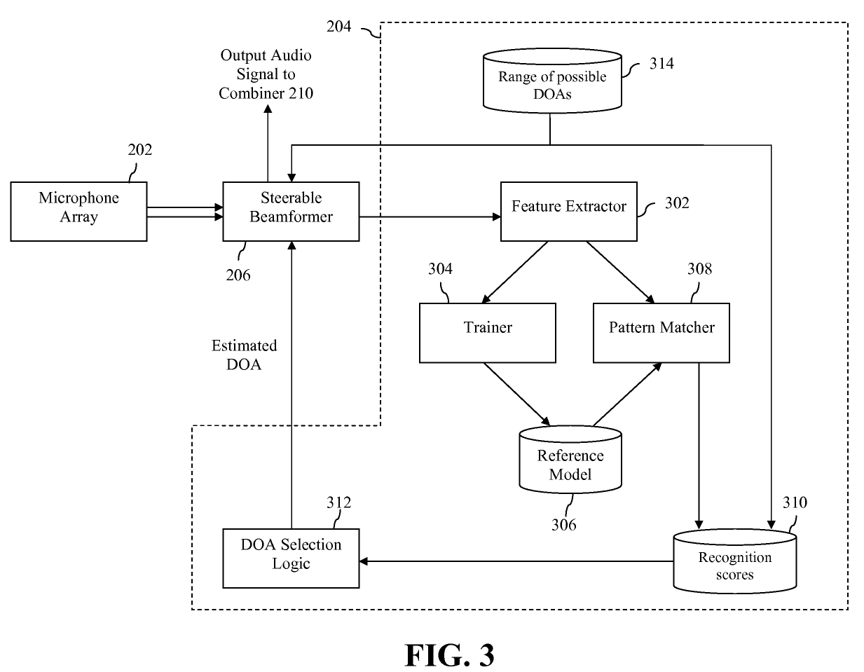

FIG. 3 is a block diagram that depicts one implementation of speech DOA estimator 204 of FIG. 2. As discussed above in reference to FIG. 2, speech DOA estimator 204 is configured to determine an estimated DOA of speech sound waves emanating from a desired speaker with respect to microphone array 202 and to provide the estimated DOA to steerable beamformer 206. As will be described in more detail below, speech DOA estimator 204 advantageously utilizes speaker recognition functionality to model and subsequently recognize speech signals generated by the desired speaker when mobile telephony terminal 100 is operated in a speakerphone mode, thereby facilitating a highly accurate determination of the estimated DOA.

As shown in FIG. 3, speech DOA estimator 204 includes a feature extractor 302, a trainer 304, a pattern matcher 308, and DOA selection logic 312. Each of these components will now be briefly described. It is to be understood that each of these components may be implemented in hardware using analog and/or digital circuits, in software, through the execution of instructions by one or more general purpose or special-purpose processors, or as a combination of hardware and software.

Generally speaking, feature extractor 302 is configured to acquire speech data that has been received by microphone array 202 and processed by steerable beamformer 206 and to extract certain features therefrom.

In particular, feature extractor 302 is configured to operate during a training process that is executed when a user of mobile telephony terminal 100 first places or receives a telephone call. During the training process, feature extractor 302 extracts features from speech data that has been obtained while the directional response of microphone array 202 as controlled by steerable beamformer 206 is fixed, wherein the fixed directional response is based on a fixed DOA. As will be discussed in more detail herein, the particular fixed directional response used by steerable beamformer 206 during the training process may depend on whether the training process is executed while mobile telephony terminal 100 is being operated in a handset mode or a speakerphone mode.

Feature extractor 302 is also configured to operate during a pattern matching process that is executed when mobile telephony terminal 100 is used in a speakerphone mode after the training process has completed. During the pattern matching process, feature extractor 302 extracts features from speech data that has been obtained across a variety of different directional responses of microphone array 202 as controlled by steerable beamformer 206. Each directional response used for feature extraction corresponds to a unique DOA in a range of possible DOAs 314 stored in local memory within mobile telephony device 100.

In one implementation, feature extractor 302 extracts features from speech data by processing multiple intervals of the speech data, which are referred to herein as frames, and mapping each frame to a multidimensional feature space, thereby generating a feature vector for each frame. For speaker recognition, features that exhibit high speaker discrimination power, high interspeaker variability, and low intraspeaker variability are desired. Examples of various features that feature extractor 302 may extract from the acquired speech data are described in Campbell, Jr., J., “Speaker Recognition: A Tutorial,” Proceedings of the IEEE, Vol. 85, No. 9, September 1997, the entirety of which is incorporated by reference herein. Such features may include, for example, reflection coefficients (RCs), log-area ratios (LARs), arcsin of RCs, line spectrum pair (LSP) frequencies, and the linear prediction (LP) cepstrum.

Trainer 304 is configured to receive features extracted from speech data by feature extractor 302 during the aforementioned training process and to process such features to generate a reference model 306 for a desired speaker. After reference model 306 has been generated, trainer 304 stores the model in local memory for subsequent use by pattern matcher 308.

Pattern matcher 308 is configured to receive features extracted by feature extractor 302 from speech data obtained using various directional responses of microphone array 202 during the aforementioned pattern matching process, wherein each directional response corresponds to a possible DOA value in range of possible DOAs 314. For each set of features associated with a particular DOA, pattern matcher 308 processes the set of features for comparison with reference model 306. Pattern matcher 308 then compares the processed feature set to reference model 306 and generates a recognition score for the corresponding DOA based on the degree of similarity between the processed feature set and reference model 306. Generally speaking, the greater the similarity between the processed feature set and reference model 306, the more likely that the DOA corresponding to the feature set represents the DOA of speech sound waves from the desired speaker (i.e., the speaker whose speech is modeled by reference model 306). In one embodiment, the higher the score, the greater the similarity between the processed feature set and reference model 306. Pattern matcher 308 then stores the recognition scores 310 associated with each of the possible DOAs 314 in local memory of mobile telephony device 100.

DOA selection logic 312 is configured to provide an estimated DOA to steerable beamformer 206. The estimated DOA provided by DOA selection logic 312 is used by steerable beamformer 206 to select a directional response of microphone array 202 for generating the output audio signal to be provided to combiner 210. During handset operation of mobile telephony terminal 100, DOA selection logic 312 is configured to provide a fixed DOA estimate to steerable beamformer 206 as discussed above in reference to FIG. 2. During speakerphone operation of mobile telephony terminal 100, DOA selection logic 312 is configured to periodically obtain recognition scores 310 from local memory of mobile telephony device 100 and to use the recognition scores to determine which DOA in range 314 of possible DOAs provides the current best estimate of the DOA of speech emanating from the desired speaker.

### D. Example Speech DOA Estimation Methods in Accordance with Embodiments of the Present Invention

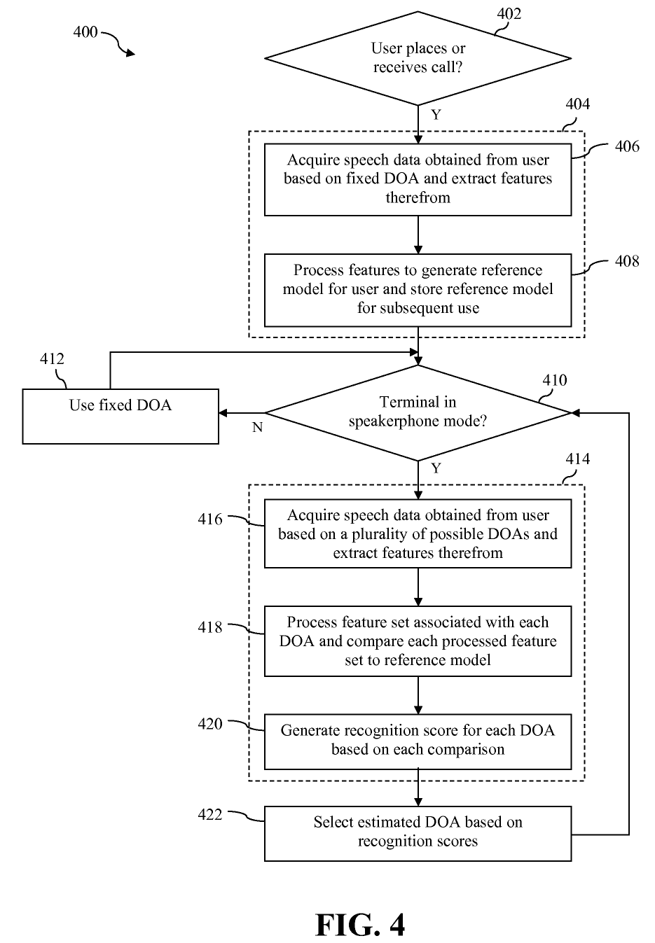

FIG. 4 depicts a flowchart 400 of a general method by which speech DOA estimator 204 of mobile telephony terminal 100 may operate to estimate a DOA of speech sound waves emanating from a desired speaker. Although the method of flowchart 400 will be described herein with continued reference to components of mobile telephony terminal 100 described above in reference to FIGS. 1-3, persons skilled in the relevant art(s) will readily appreciate that the method is not limited to that implementation.

As shown in FIG. 4, the method of flowchart 400 begins at decision step 402, in which DOA estimator 204 determines whether or not a user of mobile telephony terminal 100 has placed (or is placing) a telephone call or has received a telephone call.

Responsive to determining that the user of mobile telephony terminal 100 has placed (or is placing) a telephone call or has received a telephone call, DOA estimator initiates a training process 404. As shown in FIG. 4, training process 404 includes at least two steps denoted steps 406 and 408.

During step 406 of training process 404, feature extractor 302 acquires speech data obtained from the user based on a fixed DOA and extracts features therefrom. As will be discussed in more detail below, the fixed DOA used to obtain the speech data may be selected in a manner that depends on whether the telephone call has been placed or received in handset mode or speakerphone mode. The fixed DOA is used by steerable beamformer 206 to control the directional response of microphone array 202 used in obtaining the speech data.

In an embodiment, the extraction of features from the speech data comprises processing multiple frames of the speech data and mapping each frame to a multidimensional feature space, thereby generating a feature vector for each frame. As previously noted, various examples of features that may be extracted during this step are described in Campbell, Jr., J., “Speaker Recognition: A Tutorial,” Proceedings of the IEEE, Vol. 85, No. 9, September 1997, the entirety of which has been incorporated by reference herein. In one embodiment, a vector of voiced features is extracted for each processed frame of the speech data. For example, the vector of voiced features may include 10 LARs or 10 LSP frequencies associated with a frame.

During step 408 of training process 404, trainer 304 processes the features extracted during step 406 to generate reference model 306 for the user and stores reference model 306 in local memory of mobile telephony device 100 for subsequent use. In an example embodiment in which the extracted features comprise a series of N feature vectors x₁, x₂, . . . x_{N} corresponding to N frames of speech data, processing the features may comprise calculating a mean vector μ̅ and covariance matrix C where the mean vector μ̅ may be calculated in accordance with

$$\overline{μ} = \frac{1}{N} {\sum }_{i = 1}^{N} {\overline{x}}_{i}$$

and the covariance matrix C may be calculated in accordance with

$$C = \frac{1}{N - 1} {\sum }_{i = 1}^{N} ( {\overline{x}}_{i} - \overline{μ} ) \cdot {( {\overline{x}}_{i} - \overline{μ} )}^{T} .$$

However, this is only one example, and a variety of other methods may be used to process the extracted features to generate reference model 306. Examples of such other methods are described in the aforementioned reference by Campbell, Jr., as well as elsewhere in the art.

At decision step 410, after training process 404 has completed, DOA estimator 204 determines whether mobile telephony terminal 410 is currently operating in speakerphone mode. If mobile telephony terminal 410 is not currently operating in speakerphone mode (i.e., if mobile telephony terminal 410 is currently operating in handset mode), then DOA selection logic 312 provides a fixed DOA to steerable beamformer 206. The fixed DOA provided by DOA selection logic 312 is used by steerable beamformer 206 to select a fixed directional response of microphone array 202 for generating an output audio signal to be provided to combiner 210.

However, if DOA estimator 204 determines during decision step 410 that mobile telephony terminal 410 is currently operating in speakerphone mode, then DOA estimator 204 initiates a pattern matching process 414. As shown in FIG. 4, pattern matching process 414 includes at least three steps denoted steps 416, 418 and 420.

During step 416 of pattern matching process 414, feature extractor 302 acquires speech data obtained from the user across a variety of different directional responses of microphone array 202 as controlled by steerable beamformer 206 and extracts features therefrom. Each directional response used for acquiring speech data is determined based on a unique DOA in range of possible DOAs 314. This step results in the generation of a set of extracted features for each unique DOA used for speech data acquisition.

Step 416 preferably includes extracting the same feature types as were extracted during step 406 of training process 404 to generate reference model 306. For example, in an embodiment in which step 406 comprises extracting a feature vector of 10 LARs or 10 LSP frequencies for each frame of speech data processed, step 416 may also include extracting a feature vector of 10 LARs or 10 LSP frequencies for each frame of speech data processed.

During step 418 of pattern matching process 414, pattern matcher 308 processes each set of extracted features associated with each unique DOA used for speech data acquisition during step 416 to generate a processed feature set that is suitable for comparison with reference model 306. In further accordance with a previously-described example embodiment, generating a processed feature set may comprise calculating a mean vector μ̅ and covariance matrix C. To improve performance during step 418, these elements may be calculated recursively for each frame of speech data received. For example, denoting an estimate based upon N frames as μ̅_{N} and on N+1 frames as μ̅_{N+1}, the mean vector may be calculated recursively in accordance with

$${\overline{μ}}_{N + 1} = {\overline{μ}}_{N} + \frac{1}{N + 1} ( {\overline{x}}_{N + 1} - {\overline{μ}}_{N} ) .$$

Similarly, the covariance matrix C may be calculated recursively in accordance with

$${C}_{N + 1} = \frac{N - 1}{N} {C}_{N} + \frac{1}{N + 1} ( {\overline{x}}_{N + 1} - {μ}_{N} ) \cdot {( {\overline{x}}_{N + 1} - {\overline{μ}}_{N} )}^{T} .$$

However, this is only one example, and a variety of other methods may be used to process each set of extracted features. Examples of such other methods are described in the aforementioned reference by Campbell, Jr., as well as elsewhere in the art.

During step 418, pattern matcher 308 further compares each processed feature set corresponding to a unique DOA to reference model 306.

During step 420 of pattern matching process 414, pattern matcher 308 generates a recognition score for each unique DOA based on the degree of similarity between the processed feature set associated with the unique DOA and reference model 306. Generally speaking, the greater the similarity between the processed feature set and reference model 306, the more likely that the DOA corresponding to the feature set represents the DOA of speech sound waves from the user. In one embodiment, the higher the score, the greater the similarity between the processed feature set and reference model 306. Pattern matcher 308 then stores the recognition scores 310 associated with each of the possible values 314 in local memory of mobile telephony device 100.

During step 422, DOA selection logic 312 obtains recognition scores 310 from local memory of mobile telephony device 100 and uses recognition scores 310 to determine which DOA in range of possible DOAs 314 provides the current best estimate of the DOA of speech emanating from the user. DOA selection logic 312 then provides the best estimate of the DOA to steerable beamformer 206 which uses the estimated DOA to select a directional response of microphone array 202 for generating an output audio signal to be provided to combiner 210.

After step 412 has been performed responsive to a determination that mobile telephony terminal 100 is operating in handset mode or steps 416, 418, 420 and 422 have been performed responsive to a determination that mobile telephony terminal 100 is operating in speakerphone mode, control returns to decision step 410. Decision step 410 is then performed again to determine whether a fixed DOA should be provided to steerable beamformer 206 or whether an updated estimated DOA based on new recognition scores should be provided. This logical loop may be performed periodically throughout the duration of a telephone call to ensure that the appropriate method is being used to provide an estimated DOA to steerable beamformer 206 and to dynamically update the estimated DOA when mobile telephony terminal 100 is operating in speakerphone mode.

In one embodiment of the present invention, the manner in which training process 404 is carried out is dependent upon whether the user has placed a call in handset mode, is placing a call in speakerphone mode, has received a call in handset mode or has received a call in speakerphone mode. A manner in which training process 404 may be carried out for each of these scenarios will now be described.

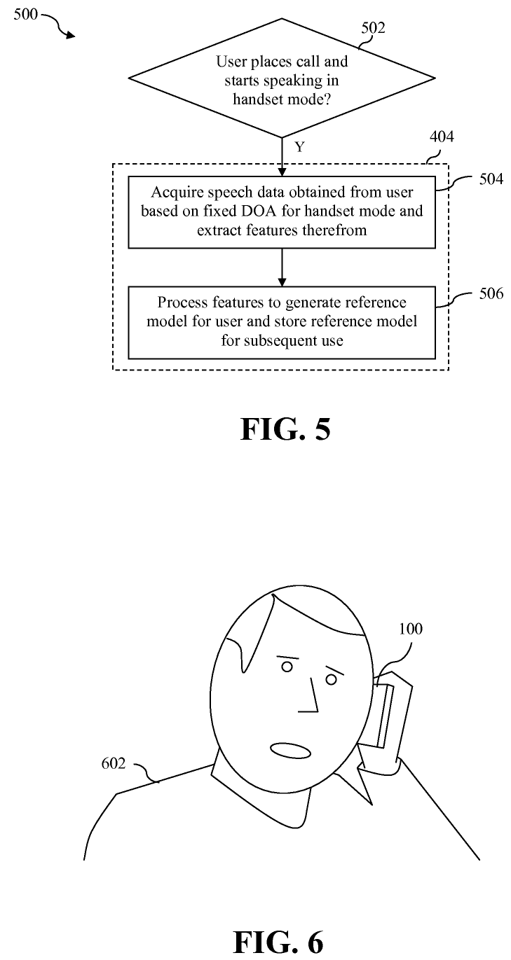

The scenario in which a user has placed a call in handset mode will be addressed first in reference to flowchart 500 of FIG. 5. As shown at decision step 502 of that flowchart, the training process in this instance is initiated when it is determined that the user has placed a call and started talking into mobile telephony terminal 100 while in handset mode. In this case, the acquisition of speech data from the user for feature extraction is carried out by steerable beamformer 206 based on a fixed DOA that is associated with the handset mode, as shown at step 504. The fixed DOA is preferably selected during manufacturing to optimize the reception of speech signals from a user when mobile telephony terminal 100 is being used in handset mode. The fixed DOA may be selected based on factors such as the design of terminal 100 and the anticipated manner in which a user will hold mobile telephony terminal 100 to their face while speaking in handset mode. For example, FIG. 6 depicts one example of how a user 602 might be expected to hold mobile telephony terminal 100 to their face during handset mode. Once the speech data has been acquired, feature extraction occurs as further shown at step 504 and then the extracted features are processed to generate a reference model for the user as shown at step 506.

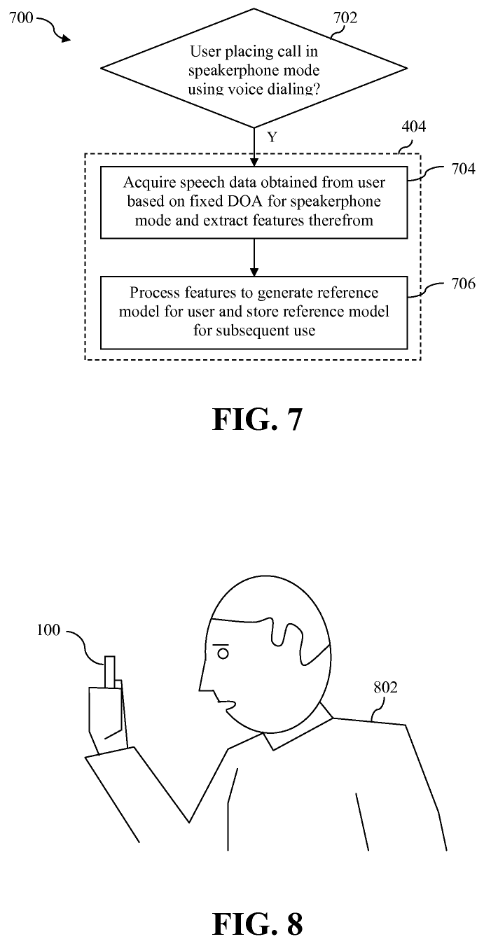

The scenario in which a user is placing a call in speakerphone mode will now addressed in reference to flowchart 700 of FIG. 7. As shown at decision step 702 of that flowchart, the training process in this instance is initiated when it is determined that the user is placing a call in speakerphone mode using voice dialing. In this case, the acquisition of speech data from the user for feature extraction is carried out by steerable beamformer 206 based on a fixed DOA that is associated with the speakerphone mode, as shown at step 704. The fixed DOA is preferably selected during manufacturing to optimize the reception of speech signals from a user when mobile telephony terminal 100 is being used in speakerphone mode. The fixed DOA may be selected based on factors such as the design of terminal 100 and the anticipated manner in which a user will hold mobile telephony terminal 100 to perform voice dialing while in speakerphone mode. For example, FIG. 8 depicts one example of how a user 802 might be expected to hold mobile telephony terminal 100 to perform voice dialing while in speakerphone mode. In this case, the fixed DOA may be selected to correspond to, for example, a 0° angle of arrival as the user is directly in front of mobile telephony terminal 100.

Depending upon the implementation, the speech data acquired during step 704 may include the digits spoken by the user during voice dialing as well as upon words spoken by the user after the call has been established. Once the speech data has been acquired, feature extraction occurs as further shown at step 704 and then the extracted features are processed to generate a reference model for the user as shown at step 706.

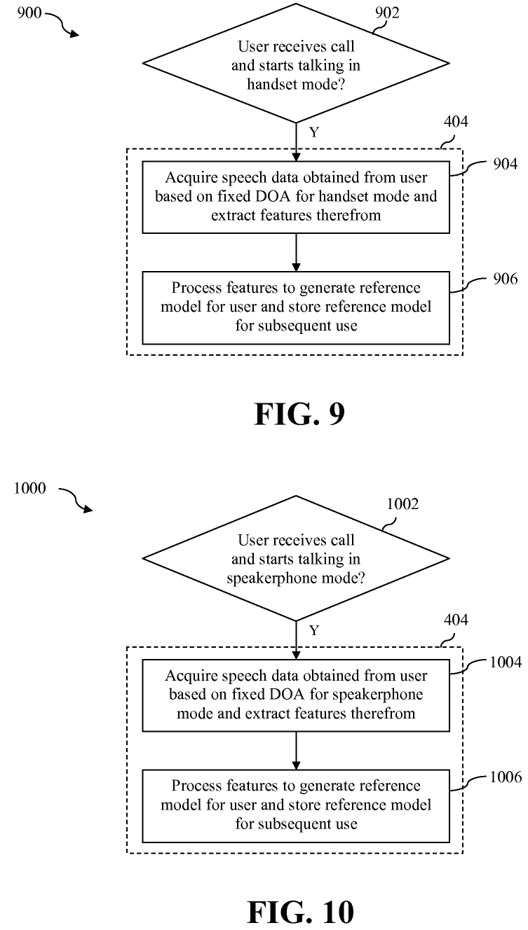

The scenario in which a user has received a call in handset mode will now be addressed in reference to flowchart 900 of FIG. 9. As shown at decision step 902 of that flowchart, the training process in this instance is initiated when it is determined that the user has received a call and started talking into mobile telephony terminal 100 while in handset mode. In this case, the acquisition of speech data from the user for feature extraction is carried out by steerable beamformer 206 based on a fixed DOA that is associated with the handset mode, as shown at step 904. The fixed DOA is preferably selected during manufacturing to optimize the reception of speech signals from a user when mobile telephony terminal 100 is being used in handset mode and, in an embodiment, comprises the same fixed DOA used during step 504 of FIG. 5. Once the speech data has been acquired, feature extraction occurs as further shown at step 904 and then the extracted features are processed to generate a reference model for the user as shown at step 906.

The scenario in which a user has received a call in speakerphone mode will now be addressed in reference to flowchart 1000 of FIG. 10. As shown at decision step 1002 of that flowchart, the training process in this instance is initiated when it is determined that the user has received a call and started talking into mobile telephony terminal 100 while in speakerphone mode. In this case, the acquisition of speech data from the user for feature extraction is carried out by steerable beamformer 206 based on a fixed DOA that is associated with the speakerphone mode, as shown at step 1004. The fixed DOA is preferably selected during manufacturing to optimize the reception of speech signals from a user when mobile telephony terminal 100 is being used in speakerphone mode and, in an embodiment, comprises the same fixed DOA used during step 704 of FIG. 7. Once the speech data has been acquired, feature extraction occurs as further shown at step 1004 and then the extracted features are processed to generate a reference model for the user as shown at step 1006.

### E. Alternative Speech DOA Estimators in Accordance with an Embodiment of the Present Invention

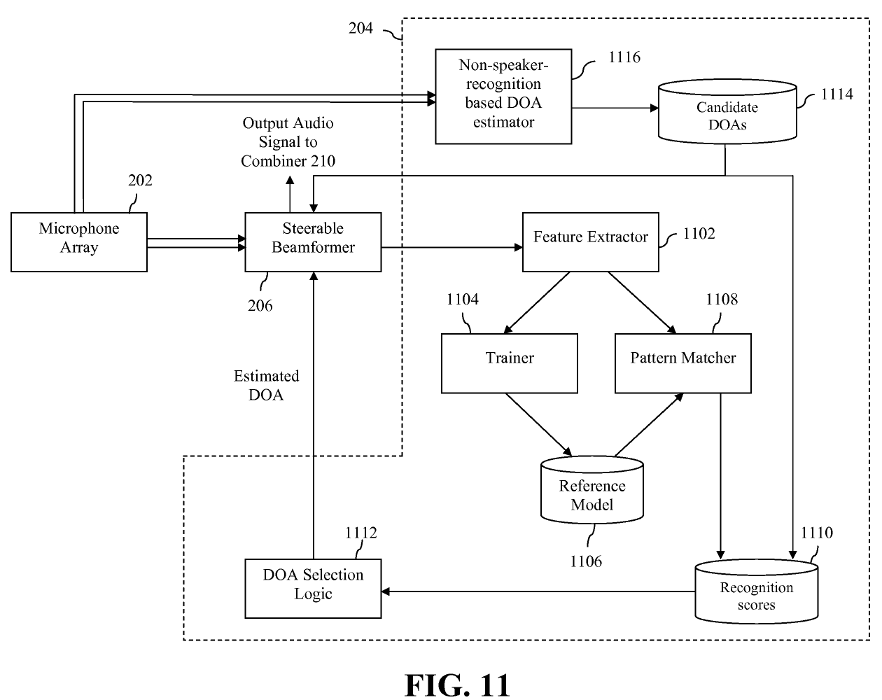

FIG. 11 is a block diagram that depicts an alternate implementation of speech DOA estimator 204. In accordance with the implementation shown in FIG. 11, when a user places or receives a telephone call using mobile telephony terminal 100, a feature extractor 1102 and a trainer 1104 operate in a similar manner to like-named elements described above in reference to FIG. 3 to generate a reference model 1106 for the user. Then, during speakerphone mode, a non-speaker-recognition based DOA estimator 1116 operates in a manner to be described herein to generate a set of candidate DOAs 1114 based on audio signals received from microphone array 202. Feature extractor 1102 and a pattern matcher 1108 then operate in a similar manner to like-named elements described above in reference to FIG. 3 to generate recognition scores 1110 for each DOA in the set of candidate DOAs 1114. Finally, DOA selection logic 1112 selects a best estimated DOA from among the candidate DOAs based on recognition scores 1110.

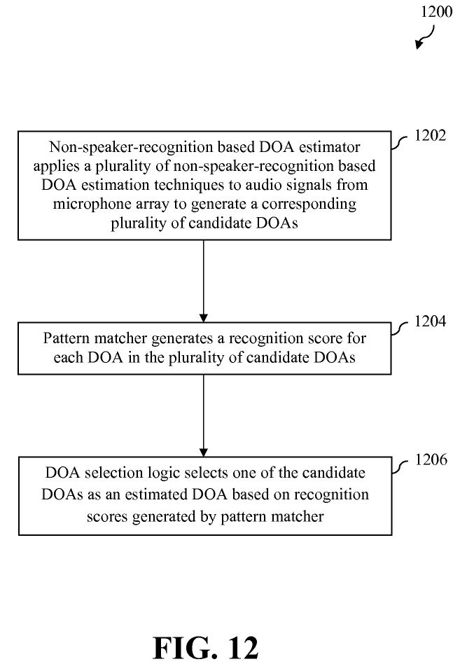

FIG. 12 depicts a flowchart 1200 of one method by which DOA estimator 204 depicted in FIG. 11 may operate to determine an estimated DOA. As shown in FIG. 12, the method of flowchart begins at step 1202 in which non-speaker-recognition based DOA estimator 1116 applies a plurality of non-speaker-recognition based DOA estimation techniques to audio signals received from microphone array 202 to generate a corresponding plurality of candidate DOAs. At step 1204, pattern matcher 1108 generates a recognition score for each DOA in the plurality of candidate DOAs. At step 1206, DOA selection logic 1112 selects one of the candidate DOAs as an estimated DOA based on the recognition scores generated by pattern matcher 1108 during step 1204. In accordance with this method, the speaker recognition functionality within DOA estimator 204 can advantageously be used to select the best results from among results produced by a plurality of non-speaker-recognition based DOA estimators.

The plurality of non-speaker-recognition based DOA estimation techniques applied during step 1202 may comprise for example a correlation-based DOA estimation technique, an adaptive eigenvalue DOA estimation technique, and/or any other non-speaker-recognition based DOA estimation technique known in the art.

Examples of various correlation-based DOA estimation techniques that may be applied by non-speaker-recognition based DOA estimator 1116 during step 1202 are described in Chen et al., “Time Delay Estimation in Room Acoustic Environments: An Overview,” EURASIP Journal on Applied Signal Processing, Volume 2006, Article ID 26503, pages 1-9, 2006 and Carter, G. Clifford, “Coherence and Time Delay Estimation”, Proceedings of the IEEE, Vol. 75, No. 2, February 1987, the entirety of which are incorporated by reference herein.

Application of a correlation-based DOA estimation technique in an embodiment in which microphone array 202 comprises two microphones may involve computing the cross-correlation between audio signals produced by the two microphones for various lags and choosing the lag for which the cross-correlation function attains its maximum. The lag corresponds to a time delay from which an angle of arrival may be deduced.

So, for example, the audio signal produced by a first of the two microphones at time t, denoted x₁(t), may be represented as:

x₁(t)=h₁(t)*s₁(t)+n₁(t)

wherein s₁(t) represents a signal from an audio source at time t, n₁(t) is an additive noise signal at the first microphone at time t, h₁(t) represents a channel impulse response between the audio source and the first microphone at time t, and * denotes convolution. Similarly, the audio signal produced by the second of the two microphones at time t, denoted x₂(t), may be represented as:

x₂(t)=h₂(t)*s₁(t−τ)+n₂(t)

wherein τ is the relative delay between the first and second microphones, n₁(t) is an additive noise signal at the second microphone at time t, and h₁(t) represents a channel impulse response between the audio source and the second microphone at time t.

The cross correlation between the two signals x₁(t) and x₂(t) may be computed for a range of lags denoted τₑₛₜ. The cross-correlation can be computed directly from the time signals as:

$${R}_{{x}_{1} {x}_{2}} ( {τ}_{est} ) = E [ {x}_{1} ( t ) \cdot {x}_{2} ( t + {τ}_{est} ) ] = \frac{1}{N} {\sum }_{n = 0}^{N - 1} {x}_{1} ( n ) \cdot {x}_{2} ( n + {τ}_{est} )$$

wherein E[.] stands for the mathematical expectation. The value of τₑₛₜ that maximizes the cross-correlation, denoted \hat{τ}_{DOA}, is chosen as the one corresponding to the best DOA estimate:

$${\hat{τ}}_{DOA} = arg {max}_{{τ}_{est}} {R}_{{x}_{1} {x}_{2}} ( {τ}_{est} ) .$$

The value \hat{τ}_{DOA} can then be used to deduce the angle of arrival θ in accordance with

$$cos ( θ ) = \frac{c \cdot {\hat{τ}}_{DOA}}{d}$$

wherein c represents the speed of sound and d represents the distance between the first and second microphones.

The cross-correlation may also be computed as the inverse Fourier Transform of the cross-PSD (power spectrum density):

Rₓ_{₁}ₓ_{₂}(τₑₛₜ)=∫W(w)·X₁(w)·X₂*(w)·e^{jwτ}^{ₑₛₜ}dw.

In addition, when power spectrum density formulas are used, various weighting functions over the frequency bands may be used. For instance, the so-called Phase Transform based weight has an expression:

$${R}_{01}^{p} ( {τ}_{est} ) = \int \frac{{X}_{1} ( f ) {X}_{2}^{*} ( f )}{\vert {X}_{1} ( f ) \vert \vert {X}_{2} ( f ) \vert} {e}^{j2π f {τ}_{est}} d f .$$

See, for example, Chen et al. as mentioned above, as well as Knapp and Carter, “The Generalized Correlation Method for Estimation of Time Delay,” IEEE Transactions on Acoustics, Speech, and Signal Processing, vol. 24, no. 4, pp. 320-327, 1976, and U.S. Pat. No. 5,465,302 to Lazzari et al. These references are incorporated by reference herein in their entirety.

As noted above, the correlation-based DOA estimation techniques applied by non-speaker-recognition based DOA estimator 1116 during step 1202 may also include an adaptive eigenvalue DOA estimation technique. As will be appreciated by persons skilled in the art, such a technique may involve adaptively estimating the time delay between two microphones by minimizing the means square of the error signal defined as

e(n)=s(n)*[h₁(n)*w₁(n)+h₂(n)*w₂(n)]

See, for example, Y. Huang et al., “Adaptive Eigenvalue Decomposition Algorithm for Realtime Acoustic Source Localization System,” IEEE, 1999, the entirety of which is incorporated by reference herein. Various adaptation schemes may be used and the time delay that yields a minimum error is selected.

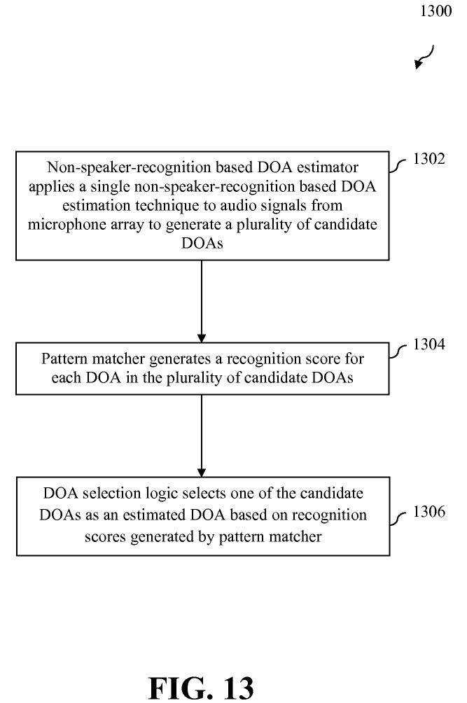

In the foregoing method of flowchart 1200, multiple non-speaker-recognition based DOA techniques are used to generate a plurality of candidate DOA estimates and then a speaker recognition based DOA technique is used to select a best DOA estimate from among the plurality of candidate DOA estimates. In an alternate embodiment of the present invention to be described below in reference to flowchart 1300 of FIG. 13, a single non-speaker-recognition based DOA technique is used to generate a plurality of candidate DOA estimates and then a speaker recognition based DOA technique is used to select a best DOA estimate from among the plurality of candidate DOA estimates. The method of flowchart 1300 will now be described with continued reference to the implementation of DOA estimator 204 depicted in FIG. 11.

As shown in FIG. 13, the method of flowchart 1300 begins at step 1302 in which non-speaker-recognition based DOA estimator 1116 applies a single non-speaker-recognition based DOA estimation technique to audio signals received from microphone array 202 to generate a plurality of candidate DOAs. For example, in an embodiment in which the non-speaker-recognition based DOA estimation technique is a correlation-based DOA estimation technique, application of the autocorrelation function may generate more than one maximum, which implies the presence of more than one dominant audio source. Thus the correlation-based method may generate a candidate DOA for each dominant audio source.

For example, in a specific embodiment, step 1302 comprises the application by non-speaker-recognition based DOA estimator 1116 of a sub-band based cross-correlation DOA estimation technique to audio signals received from microphone array 202. As will be appreciated by persons skilled in the relevant art(s), sub-band processing is commonly used in speech processing systems to perform functions such as echo cancellation or noise reduction as such processing has been shown to be more computationally efficient and algorithmically more effective than full-band processing in terms of convergence speed and manageable control.

Sub-band processing generally entails dividing the frequency range of an input signal into sub-bands. The width of the sub-bands may be equal or may increase with frequency to model the human auditory perception. A number of approaches can be used to divide the signal into multiple sub-bands. These include structures such as polyphase DFT filters, cosine-modulated filters, quadrature modulated filter banks (QMF) and others. For example, see “Multirate Digital Filters, Filter Banks, Polyphase Networks, and Applications: A Tutorial: by P. P. Vaidyanathan, IEEE (1990). In accordance with any of these methods, the generated sub-band signals could be either real or complex. Aside from this, the processes to be performed on each sub-band signal may be similar to processes that could have otherwise been performed to the original time-domain signal (e.g., computing correlations, etc.).

Given this background, it will be appreciated that application of a sub-band based cross-correlation DOA estimation technique to audio signals received from microphone array 202 results in the location of a lag in each of a plurality of frequency sub-bands where an autocorrelation function is at a maximum. So, for M frequency sub-bands, a set of M lags will be produced. This set may be further reduced by histogramming and selecting a small number (e.g., 2 or 3) of dominant peaks corresponding to dominant audio sources. The lag corresponding to each of the dominant peaks comprises a candidate DOA estimate.

At step 1304, pattern matcher 1108 generates a recognition score for each DOA in the plurality of candidate DOAs generated during step 1302.

At step 1306, DOA selection logic 1112 selects one of the candidate DOAs as an estimated DOA based on the recognition scores generated by pattern matcher 1108 during step 1304. In accordance with this method, the speaker recognition functionality within DOA estimator 204 can advantageously be used to select the best results from among results produced by a single non-speaker-recognition based DOA estimator, such as a correlation-based DOA estimator.

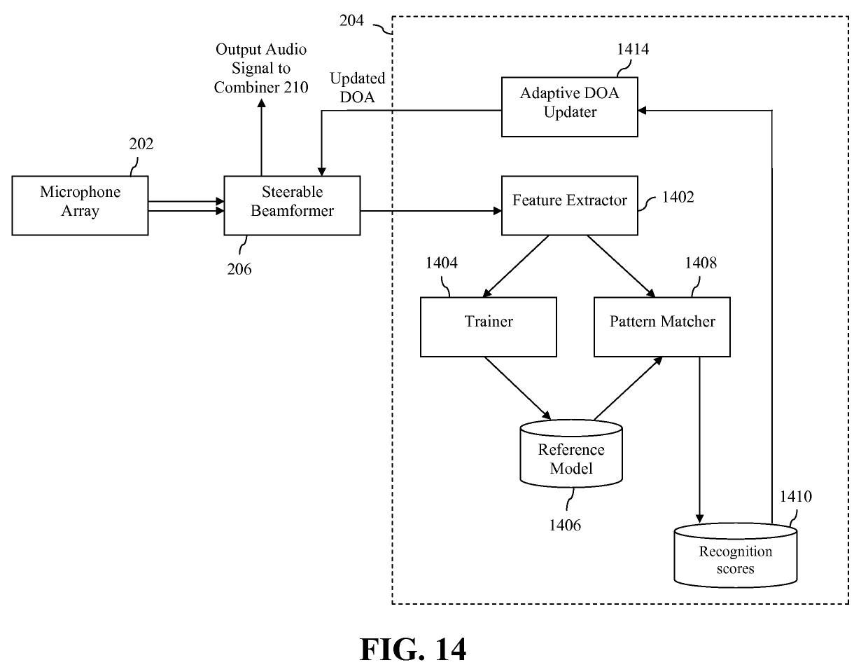

FIG. 14 is a block diagram that depicts a further alternate implementation of speech DOA estimator 204. The embodiment shown in FIG. 14 uses speaker-recognition techniques in conjunction with an adaptation scheme to gradually steer the directional response of a microphone array towards a desired speaker.

In accordance with the implementation shown in FIG. 14, when a user places or receives a telephone call using mobile telephony terminal 100, a feature extractor 1402 and a trainer 1404 operate in a similar manner to like-named elements described above in reference to FIG. 3 to generate a reference model 1406 for the user. Then, when speakerphone mode is initiated, an adaptive DOA updater 1414 provides an initial DOA to steerable beamformer 206 which steers a directional response of microphone array 202 in accordance with the initial DOA. The initial DOA may be, for example, a fixed DOA used during training. As previously described, the fixed DOA that is selected for use during training may depend upon whether a user has placed, is placing, or has received the telephony call using the mobile telephony terminal in a handset mode or a speakerphone mode.

After the directional response of microphone array 202 has been steered in accordance with the initial DOA, feature extractor 1402 and a pattern matcher 1408 operate in a similar manner to like-named elements described above in reference to FIG. 3 to generate a recognition score 1410 for the initial DOA. This recognition score is provided to adaptive DOA updater 1414. DOA updater 1414 uses the recognition score, and perhaps other parameters, to determine an adjustment to the initial DOA and applies the adjustment to the initial DOA. The updated DOA is then provided to steerable beamformer 206, which uses the updated DOA to adjust the directional response of microphone array 202. This process can then be repeated iteratively, with new updated DOAs being provided by adaptive DOA updater based on new recognition scores, thereby gradually steering the directional response of microphone array 202 towards a desired speaker.

The incremental adjustment to the DOA applied by adaptive DOA updater 1414 may be positive or negative and can be a function of a number of parameters, including but not limited to current and past recognition scores 1410, a signal-to-noise ratio at the output of steerable beamformer 206, the energy level at the output of steerable beamformer 206, or the like. In one implementation, the adaptation equation may be of the form:

τₙ₊₁=τₙ+μ·Δτ

where τₙ represents the current DOA, τₙ₊₁ represents the updated DOA, Δτ represents the incremental adjustment function and μ represents an adaptation constant. However, this is only one example of an adaptation equation and other equations may be used.

### F. Example Computer System Implementation

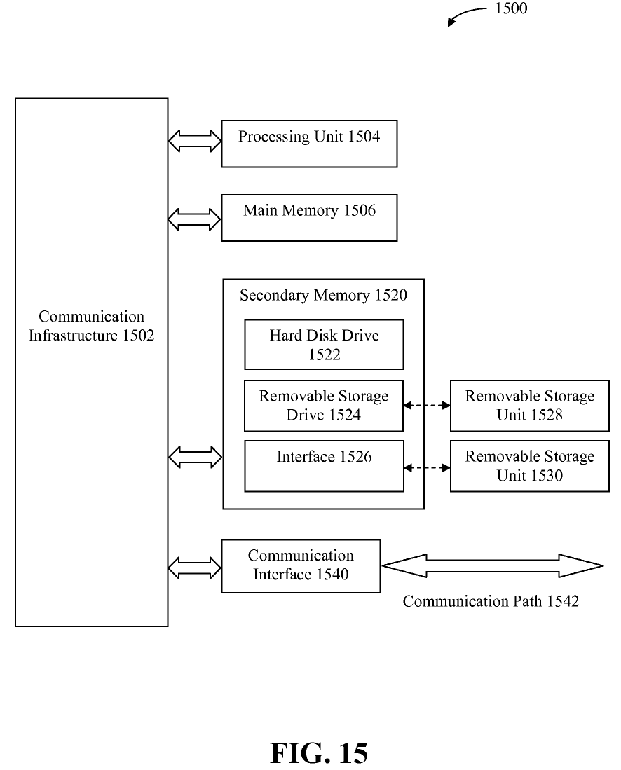

Each of the functional elements of the various systems depicted in FIGS. 2, 3, 11 and 14 and each of the steps of the flowchart depicted in FIGS. 4, 5, 7, 9, 10, 12 and 13 may be implemented by one or more processor-based computer systems. An example of such a computer system 1500 is depicted in FIG. 15.

As shown in FIG. 15, computer system 1500 includes a processing unit 1504 that includes one or more processors. Processor unit 1504 is connected to a communication infrastructure 1502, which may comprise, for example, a bus or a network.

Computer system 1500 also includes a main memory 1506, preferably random access memory (RAM), and may also include a secondary memory 1520. Secondary memory 1520 may include, for example, a hard disk drive 1522, a removable storage drive 1524, and/or a memory stick. Removable storage drive 1524 may comprise a floppy disk drive, a magnetic tape drive, an optical disk drive, a flash memory, or the like. Removable storage drive 1524 reads from and/or writes to a removable storage unit 1528 in a well-known manner. Removable storage unit 1528 may comprise a floppy disk, magnetic tape, optical disk, or the like, which is read by and written to by removable storage drive 1524. As will be appreciated by persons skilled in the relevant art(s), removable storage unit 1528 includes a computer usable storage medium having stored therein computer software and/or data.

In alternative implementations, secondary memory 1520 may include other similar means for allowing computer programs or other instructions to be loaded into computer system 1500. Such means may include, for example, a removable storage unit 1530 and an interface 1526. Examples of such means may include a program cartridge and cartridge interface (such as that found in video game devices), a removable memory chip (such as an EPROM, or PROM) and associated socket, and other removable storage units 1530 and interfaces 1526 which allow software and data to be transferred from the removable storage unit 1530 to computer system 1500.

Computer system 1500 may also include a communication interface 1540. Communication interface 1540 allows software and data to be transferred between computer system 1500 and external devices. Examples of communication interface 1540 may include a modem, a network interface (such as an Ethernet card), a communications port, a PCMCIA slot and card, or the like. Software and data transferred via communication interface 1540 are in the form of signals which may be electronic, electromagnetic, optical, or other signals capable of being received by communication interface 1540. These signals are provided to communication interface 1540 via a communication path 1542. Communications path 1542 carries signals and may be implemented using wire or cable, fiber optics, a phone line, a cellular phone link, an RF link and other communications channels.

As used herein, the terms “computer program medium” and “computer readable medium” are used to generally refer to media such as removable storage unit 1528, removable storage unit 1530 and a hard disk installed in hard disk drive 1522. Computer program medium and computer readable medium can also refer to memories, such as main memory 1506 and secondary memory 1520, which can be semiconductor devices (e.g., DRAMs, etc.). These computer program products are means for providing software to computer system 1500.

Computer programs (also called computer control logic, programming logic, or logic) are stored in main memory 1506 and/or secondary memory 1520. Computer programs may also be received via communication interface 1540. Such computer programs, when executed, enable the computer system 1500 to implement features of the present invention as discussed herein. Accordingly, such computer programs represent controllers of the computer system 1500. Where the invention is implemented using software, the software may be stored in a computer program product and loaded into computer system 1500 using removable storage drive 1524, interface 1526, or communication interface 1540.

The invention is also directed to computer program products comprising software stored on any computer readable medium. Such software, when executed in one or more data processing devices, causes a data processing device(s) to operate as described herein. Embodiments of the present invention employ any computer readable medium, known now or in the future. Examples of computer readable mediums include, but are not limited to, primary storage devices (e.g., any type of random access memory) and secondary storage devices (e.g., hard drives, floppy disks, CD ROMS, zip disks, tapes, magnetic storage devices, optical storage devices, MEMs, nanotechnology-based storage device, etc.).

### G. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for determining an estimated direction of arrival (DOA) of speech sound waves emanating from a desired speaker with respect to a microphone array, comprising:
acquiring a plurality of audio signals from a steerable beamformer corresponding to a plurality of DOAs;
processing each of the plurality of audio signals to generate a plurality of processed feature sets, wherein each processed feature set in the plurality of processed feature sets is associated with a corresponding DOA in the plurality of DOAs;
generating a recognition score for each of the processed features sets, wherein generating a recognition score for a processed feature set comprises comparing the processed feature set to a speaker recognition reference model associated with the desired speaker; and
selecting the estimated DOA from among the plurality of DOAs based on the recognition scores.

2. The method of claim 1, wherein the steerable beamformer is implemented using the microphone array.

3. The method of claim 1, wherein selecting the estimated DOA from among the plurality of DOAs based on the recognition scores comprises:
selecting one of the processed features sets from among the plurality of processed feature sets based on the recognition scores; and
selecting the DOA associated with the selected processed feature set as the estimated DOA.

4. The method of claim 1, wherein the method is implemented in a mobile telephony terminal and wherein the steps are performed responsive to determining that the mobile telephony terminal is being operated in a speakerphone mode.

5. The method of claim 1, further comprising:
providing the estimated DOA to the steerable beamformer for use in steering a directional response pattern of the microphone array toward the desired speaker.

6. The method of claim 1, further comprising:
generating the speaker recognition reference model associated with the desired speaker.

7. The method of claim 5, wherein generating the speaker recognition reference model associated with the desired speaker comprises:
acquiring speech data from the steerable beamformer based on a fixed DOA;
extracting features from the acquired speech data; and
processing the features extracted from the acquired speech data to generate the speaker recognition reference model.

8. The method of claim 7, wherein the method is implemented in a mobile telephony terminal and wherein the steps of claim 7 are performed responsive to determining that a user has placed, is placing, or has received a telephone call using the mobile telephony terminal.

9. The method of claim 8, wherein acquiring speech data from the steerable beamformer based on the fixed DOA comprises:
selecting the fixed DOA based on whether a user has placed, is placing, or has received the telephony call using the mobile telephony terminal in a handset mode or a speakerphone mode.

10. The method of claim 7, wherein extracting features from the acquired speech data comprises:
extracting features from each frame in a series of frames representing the acquired speech data; and
generating a feature vector for each frame based on the features extracted from each frame.

11. The method of claim 8, wherein processing the features extracted from the acquired speech data to generate the speaker recognition reference model comprises calculating a mean vector and covariance matrix associated with the feature vectors.

12. The method of claim 1, wherein processing each of the plurality of audio signals to generate a plurality of processed feature sets comprises:
extracting features from each audio signal in the plurality of audio signals; and
processing the features extracted from each audio signal in the plurality of audio signals to generate the processed feature set for each audio signal in the plurality of audio signals.

13. The method of claim 12, wherein extracting features from each audio signal in the plurality of audio signals comprises:
extracting features from each frame in a series of frames representing the audio signal; and
generating a feature vector for each frame based on the features extracted from each frame.

14. The method of claim 13, wherein processing the features extracted from each audio signal in the plurality of audio signals to generate a processed feature set for each audio signal in the plurality of audio signals comprises:
calculating a mean vector and covariance matrix associated with the feature vectors generated for each audio signal in the plurality of audio signals.

15. The method of claim 1, further comprising:
obtaining the plurality of DOAs from a database of possible DOAs.

16. The method of claim 1, further comprising:
obtaining the plurality of DOAs from a non-speaker-recognition based DOA estimator.

17. The method of claim 14, wherein obtaining the plurality of DOAs from a non-speaker-recognition based DOA estimator comprises:
obtaining the plurality of DOAs from a DOA estimator that applies a correlation-based DOA estimation technique to audio signals received from the microphone array.

18. A method for determining an estimated direction of arrival (DOA) of speech sound waves emanating from a desired speaker with respect to a microphone array, comprising:
applying a plurality of non-speaker-recognition based DOA estimation techniques to audio signals received from the microphone array to generate a corresponding plurality of candidate DOAs; and
applying a speaker recognition based DOA estimation technique to audio signals received from a steerable beamformer implemented using the microphone array at each of the candidate DOAs to select the estimated DOA from among the plurality of candidate DOAs.

19. The method of claim 18, wherein applying the plurality of non-speaker-recognition based DOA estimation techniques comprises applying at least one of a correlation-based DOA estimation technique or an adaptive eigenvalue based DOA estimation technique.

20. A method for determining an estimated direction of arrival (DOA) of speech sound waves emanating from a desired speaker with respect to a microphone array, comprising:
applying a non-speaker-recognition based DOA estimation technique to audio signals received from the microphone array to generate a corresponding plurality of candidate DOAs; and
applying a speaker recognition based DOA estimation technique to audio signals received from a steerable beamformer implemented using the microphone array at each of the candidate DOAs to select the estimated DOA from among the plurality of candidate DOAs.

21. The method of claim 20, wherein applying the non-speaker-recognition based DOA estimation technique to audio signals received from the microphone array to generate the corresponding plurality of candidate DOAs comprises:
applying a correlation-based DOA estimation technique to identify a plurality of DOAs corresponding to a plurality of maxima of an autocorrelation function; and
identifying each of the plurality of DOAs as a candidate DOA.

22. The method of claim 21, wherein applying the correlation-based DOA estimation technique comprises:
performing a cross-correlation for each of a plurality of lags across each of a plurality of frequency sub-bands to identify a lag for each frequency sub-band at which an autocorrelation function is at a maximum;
performing histogramming to identify a subset of lags from among the lags identified for the frequency sub-bands corresponding to a plurality of dominant audio sources; and
using each lag in the subset of lags as a candidate to determine or represent a candidate DOA.

23. A method for estimating a direction of arrival (DOA) of speech sound waves emanating from a desired speaker with respect to a microphone array, comprising:
acquiring an audio signal from a steerable beamformer corresponding to a current DOA;
processing the audio signal to generate a processed feature set;
comparing the processed feature set with a speaker recognition reference model associated with the desired speaker to generate a recognition score; and
updating the current DOA based on at least the recognition score to generate an updated DOA.

24. The method of claim 23, further comprising:
providing the updated DOA to the steerable beamformer for use in steering a directional response pattern of the microphone array toward the desired speaker.

25. The method of claim 23, wherein updating the current DOA based on at least the recognition score comprises determining an incremental adjustment to the current DOA based on at least the recognition score.
